(19) United States
(12) Patent Application Publication
(10) Pub. No.: US 2008/0196824 A1
(43) Pub. Date: Aug. 21, 2008

(54) Coloured Polymers System with Improved Colour Brilliance

(75) Inventors: Reinhold J. Leyrer, Dannstadt-Schauernheim (DE); Stephan Altmann, Deidesheim (DE); Oihana Elizalde, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 11/914,481

(22) PCT Filed: May 16, 2006
(86) PCT No.: PCT/EP2006/062350

§ 371 Date: Nov. 15, 2007

(30) Foreign Application Priority Data
May 19, 2005 (DE) 10 2005 023 806.8

(51) Int. Cl. C08K 7/00; B44C 1/16

(52) U.S. Cl. 156/231; 523/201

(57) ABSTRACT

A process for improving the color brilliance of a color polymer system which is composed of a matrix and discrete polymer particles which are distributed in the matrix in accordance with a defined spatial lattice structure and are obtained by filming an emulsion polymer with core/shell structure, the emulsion polymer being obtainable by polymerization of monomers in at least one first stage (monomers of the core) and subsequent polymerization of monomers in at least one further, second stage (monomers of the shell), which comprises polymerizing the monomers of the core in the presence of an absorber for electromagnetic waves especially a UV absorber.

The invention relates to a process for improving the color brilliance of a color polymer system which is composed of a matrix and discrete polymer particles which are distributed in the matrix in accordance with a defined spatial lattice structure and are obtained by filming an emulsion polymer with core/shell structure, the emulsion polymer being obtainable by polymerization of monomers in at least one first stage (monomers of the core) and subsequent polymerization of monomers in at least one further, second stage (monomers of the shell), which comprises polymerizing the monomers of the core in the presence of an absorber for electromagnetic waves, especially a UV absorber.

The invention further relates to color polymer systems which are obtainable by this process and to the use of the color polymer systems for coating, for example, plastics, paper or in visual displays.

DE-19717879, DE-19820302, DE-19834194 and DE-A-10321083 disclose color polymer systems in which discrete polymer particles are dispersed in a matrix.

DE 10229732 (PF 53679) describes the use of such polymer layers in visual display elements.

It was an object of the present invention to improve the color brilliance of the color polymer systems or of the color polymer films produced therefrom. The polymer films should additionally have maximum resistance toward mechanical stresses, as can occur, for example, when the polymer films are used in displays. Accordingly, the process described at the outset has been found.

The color polymer systems consist substantially of a matrix and discrete polymer particles which are distributed in the matrix in accordance with a defined spatial lattice structure.

The use of emulsion polymers with core/shell structure for producing such color polymer systems has already been described in the prior art (see DE-A-19820302, DE-A-19834194).

The color polymer system is obtained by filming an emulsion polymer with core/shell structure.

The shell of the emulsion polymer is filmable and forms the matrix, while the cores of the emulsion polymer are distributed as discrete polymer particles in the matrix.

The emulsion polymer is accordingly obtained by a multistage emulsion polymerization, in which first, in at least one 1st stage, the monomers which form the core are polymerized and then, in at least one 2nd stage, the monomers which form the filmable shell are polymerized.

The monomer composition of the core differs from that of the shell.

In the core, monomers with high glass transition temperature (Tg) are used, while the monomers of the shell have a lower Tg.

The monomer mixture of the 1st stage (core) preferably has a glass transition temperature (Tg) calculated by the Fox equation of from 0 to 150° C., more preferably from 0 to 120° C., most preferably from 0 to 110° C.

The Tg of the monomer mixture of the 2nd stage (shell), also calculated according to Fox, is preferably from −50 to 110° C., more preferably from −40 to 25° C. The Tg of the monomer mixture of the 2nd stage is preferably at least 10° C. lower, more preferably at least 20° C. lower, than the Tg of the monomer mixture of the 1st stage.

An essential feature of the present invention is that the polymerization of the monomers of the 1st and/or of the 2nd stage is carried out in the presence of an absorber for electromagnetic waves, in particular a UV absorber. Correspondingly, the polymer comprises such an absorber, especially UV absorber.

More preferably, the polymerization of the 1st stage (core) is carried out in the presence of an absorber.

Useful UV absorbers include, for example, hydroxybenzophenones or hydroxy-phenylbenzotriazoles.

Such UV absorbers are known, for example, under the trade name Uvinul® 3033P.

The amount of the absorbers is in particular from 0.1 to 5% by weight, more preferably from 0.2 to 3% by weight, based on the overall polymer. The entire amount is preferably used in the polymerization of the 1st stage.

In a preferred embodiment of the present invention, the monomer mixture of the 1St stage also comprises monomers having a Tg less than 0° C., preferably less than −20° C., more preferably less than −30° C.

The proportion of these monomers in all monomers of the 1st stage is at least 5% by weight, preferably at least 10% by weight, more preferably at least 20% by weight, in particular at least 30 or 40% by weight. The remaining monomers of the 1st stage are selected in such a way that the above Tg range of the 1st stage is satisfied.

Preferred monomers with low Tg are alkyl (meth)acrylates, in particular n-butyl acrylate and 2-ethylhexyl acrylate. The remaining monomers are in particular styrene, crosslinking monomers and if appropriate auxiliary monomers such as acrylic acid, methacrylic acid.

It is known from the prior art that the core has been crosslinked is, while the shell is uncrosslinked.

In the context of the present invention, it is preferred that the monomers of the 2nd stage (shell) also comprise crosslinking monomers.

Crosslinking monomers are in particular monomers having two polymerizable groups, for example having two vinyl groups or allyl groups. These include divinylbenzene, alkanediol diacrylates or diallyl phthalate.

The proportion of crosslinking monomers in the monomer mixture of the 1st stage is preferably from 0.5 to 25% by weight, more preferably from 1 to 7% by weight, most preferably from 2 to 6% by weight, based on the monomers of the 1st stage.

The proportion of crosslinking monomers in the monomer mixture of the 2nd stage is preferably from 0.01 to 10% by weight, more preferably from 0.1 to 5% by weight, most preferably from 0.1 to 3% by weight, based on the monomers of the 2nd stage.

The weight of the crosslinking monomers of the 1st stage is preferably at least twice as high as the weight of the crosslinking monomers of the 2nd stage.

In the context of the present invention, it is also preferred that the polymerization of the monomers of the 1st and/or of the 2nd stage is carried out in the presence of different emulsifiers. When emulsifiers having an ionic group (ionic emulsifiers) are used in the polymerization of the monomers of the core, preference is given to using emulsifiers without ionic groups (nonionic emulsifiers) in the polymerization of the monomers of the shell. Conversely, ionic emulsifiers are used in the polymerization of the monomers of the shell when the polymerization of the monomers of the core has been carried out in the presence of nonionic emulsifiers.

For the type of emulsifiers and the amount, the remarks below apply.

In a preferred embodiment for the preparation of the emulsion polymer, the monomers of the shell are metered into the polymerization within less than 90 minutes, more preferably within less than 60 minutes and in particular within less than 30 minutes. Most preferably, the monomers of the shell are polymerized in batch mode, i.e. all monomers of the shell are fed to the polymerization vessel as far as possible simultaneously, generally within a few minutes, for example not more than 10 or not more than 5 minutes, and subsequently polymerized.

Before the start of addition of the monomers of the shell, more than 90% by weight of the total amount of initiator used for the emulsion polymerization has preferably already been added; more preferably, before the start of addition of the monomers of the shell, the entire amount of initiator used for the emulsion polymerization is.

### General Remarks on the Core/Shell Polymers:

The weight ratio of the monomers which form the nonfilming core to the monomers which form the filming shell is preferably from 1:0.05 to 1:20, more preferably from 1:0.2 to 1:5.

More preferably, the following applies to the proportion of the stages of overall polymer:

1st stage (core) 10-90% by weight, more preferably 40-60% by weight.
2nd stage (shell) from 10 to 90% by weight, more preferably 40-60% by weight.

Overall, the emulsion polymer preferably consists to an extent of at least 40% by weight, preferably to an extent of at least 60% by weight, more preferably to an extent of at least 80% by weight, of so-called main monomers.

The main monomers are selected from C₁-C₂₀-alkyl (meth)acrylates, vinyl esters of carboxylic acids comprising up to 20 carbon atoms, vinylaromatics having up to 20 carbon atoms, ethylenically unsaturated nitrites, vinyl halides, vinyl ethers of alcohols comprising from 1 to 10 carbon atoms, aliphatic hydrocarbons having from 2 to 8 carbon atoms and 1 or 2 double bonds, or mixtures of these monomers.

Examples include alkyl (meth)acrylates having a C₁-C₁₀-alkyl radical, such as methyl methacrylate, methyl acrylate, n-butyl acrylate, ethyl acrylate and 2-ethylhexyl acrylate. Mixtures of the alkyl (meth)acrylates are also especially suitable.

Examples of vinyl esters of carboxylic acids having from 1 to 20 carbon atoms are vinyl laurate, vinyl stearate, vinyl propionate, vinyl versatate and vinyl acetate.

Useful vinylaromatic compounds are vinyltoluene, α- and p-methylstyrene, alpha-butylstyrene, 4-n-butylstyrene, 4-n-decylstyrene and preferably styrene. Examples of nitrites are acrylonitrile and methacrylonitrile.

The vinyl halides are chlorine-, fluorine-, or bromine-substituted, ethylenically unsaturated compounds, preferably vinyl chloride and vinylidene chloride.

Vinyl ethers include, for example, vinyl methyl ether or vinyl isobutyl ether, Preference is given to vinyl ethers of alcohols comprising from 1 to 4 carbon atoms.

Hydrocarbons having from 2 to 8 carbon atoms and one or two olefinic double bonds include butadiene, isoprene and chloroprene; with one double bond, for example, ethylene or propylene.

Preferred main monomers are the C₁-C₂₀-alkyl acrylates and C₁-C₂₀-alkyl methacrylates, in particular C₁-C₈-alkyl acrylates and C₁-C₈-alkyl methacrylates, vinylaromatics, in particular styrene, and mixtures thereof, in particular also mixtures of the alkyl (meth)acrylates and vinylaromatics, Very particular preference is given to methyl acrylate, methyl methacrylate, ethyl acrylate, n-butyl acrylate, n-hexyl acrylate, octyl acrylate and 2-ethylhexyl acrylate and styrene, and also to mixtures of these monomers.

The emulsion polymer is prepared by emulsion polymerization. In emulsion polymerization, ionic and/or nonionic emulsifiers and/or protective colloids or stabilizers are used as interface-active compounds.

A comprehensive description of suitable protective colloids can be found in Houben-Weyl, Methoden der organischen Chemie [Methods of Organic Chemistry], volume XIV/1, Makromolekulare Stoffe [Macromolecular substances], Georg-Thieme-Veriag, Stuttgart, 1961, p. 411 to 420. Useful emulsifiers are anionic, cationic or nonionic emulsifiers. The interface-active substances used are preferably emulsifiers whose molecular weight, in contrast to that of protective colloids, is typically below 2000 g/mol.

The interface-active substance is typically used in amounts of from 0.1 to 10% by weight, based on the monomers to be polymerized.

Examples of water-soluble initiators for the emulsion polymerization are the ammonium and alkali metal salts of peroxydisulfuric acid, for example sodium peroxodisulfate, hydrogen peroxide, or organic peroxides, for example tert-butyl hydroperoxide.

Also suitable are so-called reduction-oxidation (redox) initiator systems.

The redox initiator systems consist of at least one, usually inorganic, reducing agent and an inorganic or organic oxidizing agent.

The oxidation component is, for example, the initiators already mentioned above for the emulsion polymerization.

Examples of the reduction components are alkali metal salts of sulfurous acid, for example sodium sulfite, sodium hydrogensulfite, alkali metal salts of disulfurous acid, such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems can be used with additional use of soluble metal compounds whose metallic component can occur in more than one valence state.

Examples of conventional redox initiator systems are ascorbic acid/iron(II) sulfate/sodium peroxodisulfate, tert-butyl hydroperoxide/sodium disulfite, tert-butyl hydroperoxide/sodium hydroxymethanesulfinic acid. The individual components, for example the reduction component, may also be mixtures, for example a mixture of the sodium salt of hydroxymethanesulfinic acid and sodium disulfite.

The amount of the initiators is generally from 0.1 to 10% by weight, preferably from 0.5 to 5% by weight, based on the monomers to be polymerized. It is also possible to use two or more different initiators in the emulsion polymerization.

The emulsion polymerization is effected generally at from 30 to 130° C., preferably from 50 to 90° C. The polymerization medium may consist either only of water or of mixtures of water and liquids miscible with it, such as methanol. Preference is given to using only water. The emulsion polymerization may be carried out either as a batch process or in the form of a feed process, including staged or gradient method. Preference is given to the feed process in which a portion of the polymerization batch is initially charged, is heated to the polymerization temperature and begins to polymerize, and the rest of the polymerization batch is subsequently fed to the polymerization zone continuously, in stages or with superimposition of a concentration gradient while maintaining the polymerization, typically via a plurality of spatially separate feeds of which one or more comprise(s) the monomers in pure or in emulsified form. In the course of the polymerization, a polymer seed may also be initially charged for better control of the particle size, for example.

The monomers of the monomer mixture of the 1st or 2nd stage are preferably polymerized to an extent of at least 90% by weight, more preferably to an extent of at least 95% by weight and most preferably to an extent of at least 99% by weight before the addition of the monomers of the next stage is commenced.

The way in which the initiator is added to the polymerization vessel in the course of the free-radical aqueous emulsion polymerization is known to the average skilled worker. It can either be initially charged fully to the polymerization vessel or used continuously or in stages according to its consumption in the course of the free-radical aqueous emulsion polymerization. Specifically, this depends upon the chemical nature of the initiator system and on the polymerization temperature. Preference is given to initially charging a portion and to feeding the rest to the polymerization zone according to the consumption.

A uniform particle size distribution, i.e. a low polydispersity index, is obtainable by measures known to those skilled in the art, for example by variation of the amount of the interface-active compound (emulsifier or protective colloids) and/or appropriate stirrer speeds.

To remove the residual monomers, initiator is typically added even after the end of the actual emulsion polymerization, i.e. after a conversion of the monomers of at least 95%.

The individual components may be added to the reactor in the feed process from above, at the side or from below through the reactor bottom.

The emulsion polymer may be filmed in a customary manner with removal of water to form the color polymer system.

The polymer system causes a visual effect, i.e. an observable reflection as a result of interference of the light scattered at the polymer particles.

The wavelength of the reflection may lie within the entire electromagnetic spectrum depending on the separation of the polymer particles. The wavelength is preferably in the UV region, IR region and in particular in the region of visible light.

The wavelength of the observable reflection depends, according to the known Bragg equation, upon the interplanar spacings, here the distance between the polymer particles arranged in the matrix in a spatial lattice structure.

So that the desired spatial lattice structure with the desired distance between the polymer particles is established, the proportion by weight of the matrix in particular has to be selected appropriately. In the above-described preparation methods, the organic compounds, for example polymeric compounds, should be used in the appropriate amount.

The proportion by weight of the matrix, i.e. the proportion of the filming shell, is in particular such that a spatial lattice structure of the polymer particles is formed which reflects electromagnetic radiation in the desired range.

The distance between the polymer particles (in each case to the center of the particles) is suitably from 100 to 400 nm when a color effect, i.e. a reflection in the region of visible light, is desired.

To form a defined spatial lattice structure, the discrete polymer particles should preferably be of maximum size. A measure of the uniformity of the polymer particles is the so-called polydispersity index, calculated by the formula

P.I.=(D₉₀−D₁₀)/D₅₀

in which D₉₀, D₁₀ and D₅₀ designate particle diameters for which:
D₉₀: 90% by weight of the total mass of all particles have a particle diameter less than or equal to D₉₀
D₅₀: 50% by weight of the total mass of all particles have a particle diameter less than or equal to D₅₀
D₁₀: 10% by weight of the total mass of all particles have a particle diameter less than or equal to D₁₀.

Further details on the polydispersity index can be found, for example, in DE-A 19717879 (especially drawings on page 1).

The particle size distribution can be determined in a manner known per se, for example with an analytical ultracentrifuge (W. Mächtle, Makromolekulare Chemie 185 (1984) page 1025-1039) or by the method of dynamic chromatography, to derive the D₁₀, D₅₀ and D₉₀ value and determine the polydispersity index.

Alternatively, the particle size and particle size distribution can also be determined by measuring the light scattering with commercial equipment (for example Autosizer 2C from Malvern, England).

The polymer particles preferably have a D₅₀ value in the range from 0.05 to 5 μm. The polymer particles may be one particle type or a plurality of particle types with different D₅₀ value, each particle type having a polydispersit index of preferably less than 0.6, more preferably less than 0.4 and even more preferably less than 0.3 and in particular less than 0.15.

In particular, the polymer particles consist of a single particle type. The D₅₀ value is then preferably between 0.05 and 20 μm, it is more preferably between 100 and 400 nanometers.

The above remarks on the particle size and particle size distribution of the discrete polymer particles also apply to the emulsion polymer itself.

A transparent polymer layer can be applied to the color polymer system in order to improve the color brilliance and the stability of the color polymer system, as described in DE-A-10321084 or no a heating carried out as described in DE-A-10321079.

The color polymer systems obtained or obtainable by the process according to the invention have improved color brilliance, elasticity and stability.

The color polymer systems are suitable as or in coating compositions, for example for coating plastics, plastics films, fibrous systems such as textiles or paper, packaging, etc., or in visual displays with changing color of the polymer layer or for increasing the light yield in visual displays or for producing color pigments or for producing moldings which can be produced, for example, by extrusion and can be used for a wide variety of purposes for which color moldings are desired, for example in automobile construction or the household. They are also suitable for solid formulations, in particular those as described in EP-A-955323 or moldings as described in DE-A-10228228.

The invention also provides a process for producing substrates coated with a color polymer system, which comprises applying the polymer system to a temporary carrier, for example by filming an aqueous polymer system or by extrusion, and then transferring, for example laminating or pressing, the resulting coated carrier by the coated side to the substrate, and, if appropriate, subsequently removing the temporary carrier. The coated carrier can be produced by customary processes, for example by filming of an aqueous polymer dispersion or by extrusion or application under pressure of a solid polymer system. The subsequent lamination of the coated carrier to the substrate may be supported by pressure or elevated temperature. Here too, the customary processes are possible. In particular, the coated carrier can be pretensioned, for example by traction, and applied to the substrate in this tensioned form. A subsequent heat treatment can prevent blister formation and defects.

### EXAMPLES OF THE APPLICATION OF THE PATENT

All syntheses were carried out in a 2000 ml four-neck flask which was equipped with a reflux condenser, a nitrogen inlet tube, inlet tubes for the charging with the monomer emulsion and the initiator solution, and an anchor stirrer with a rotational speed of 150 per minute.

### Comparative Example

A reactor with anchor stirrer, thermometer, gas inlet tube, charging tubes and reflux condenser was initially charged with 397.28 g of water, then 1.42 g of polystyrene seed particle dispersion with a particle size of 30 nm and a solids content of 33% by mass were added. The flask contents were subsequently heated and stirred at a rotational speed of 150 min⁻¹. During this time, nitrogen was supplied to the reactor. When a temperature of 75° C. was attained, the nitrogen supply was stopped and air was prevented from getting into the reactor. Before the polymerization, 20% of a sodium peroxodisulfate solution composed of 3.5 g of sodium persulfate in 50 g of water was supplied to the reactor and preoxidized for 5 minutes, then the rest of the sodium persulfate solution was added within 4.5 hours. At the same time, monomer emulsion a) of the core was metered in for 2 hours, then polymerized for a further 30 minutes, and monomer emulsion b) of the shell was finally metered in over 2 hours. After 1.5 hours during the feeding of monomer emulsion b), feed 4 was added to monomer emulsion b). After the monomer addition had ended, the dispersion was allowed to polymerize for a further hour. Subsequently, the mixture was cooled to room temperature.

The composition of the feeds was as follows:

Feed 1: Monomer emulsion a)

| | |
|---|---|
| 116.67 | g of water |
| 8.75 | g of Texapon NSO, conc. by mass: 28% in water |
| 07 | g of sodium hydroxide solution, conc. by mass: 25% in water |
| 14.0 | g of acrylic acid |
| 14.00 | g of diallyl phthalate |
| 168.0 | g of styrene |
| 168.00 | g of n-butyl acrylate |
| 7.00 | g of rinse water |

Feed 2: Initiator solution

| | |
|---|---|
| 50 | g of sodium peroxodisulfate, conc. by mass: 7% in water |

Feed 3: Monomer emulsion b)

| | |
|---|---|
| 116.67 | g of water |
| 8.75 | g of Texapon NSO, conc. by mass: 28% in water |
| 0.7 | g of sodium hydroxide solution, conc. by mass: 25% in water |
| 7.0 | g of acrylic acid |
| 3.5 | g of diallyl phthalate |
| 63.00 | g of methyl methacrylate |
| 273.00 | g of n-butyl acrylate |
| 7.00 | g of rinse water |

Feed 4: Acrylic acid

| | |
|---|---|
| 7.00 | g of acrylic acid |
| 6.00 | g of water |

### Inventive Example

The procedure corresponded to the previous example.

Feed 1: Monomer emulsion a)

| | |
|---|---|
| 116.67 | g of water |
| 8.75 | g of Texapon NSO, conc. by mass: 28% in water |
| 0.7 | g of sodium hydroxide solution, conc. by mass: 25% in water |
| 14.0 | g of acrylic acid |
| 14.00 | g of diallyl phthalate |
| 168.0 | g of styrene |
| 14.00 | g of Uvinul 3033 P (2-(2H-benzotriazol-2-yl)-4-methylphenol) |
| 168.00 | g of n-butyl acrylate |
| 7.00 | g of rinse water |

Feed 2: Initiator solution

| | |
|---|---|
| 50 | g of sodium peroxodisulfate, conc. by mass: 7% in water |

Feed 3: Monomer emulsion b)

| | |
|---|---|
| 116.67 | g of water |
| 8.75 | g of Texapon NSO, conc. by mass: 28% in water |
| 0.7 | g of sodium hydroxide solution, conc. by mass: 25% in water |
| 7.0 | g of acrylic acid |
| 3.5 | g of diallyl phthalate |
| 63.00 | g of methyl methacrylate |
| 273.00 | g of n-butyl acrylate |
| 7.00 | g of rinse water |

Feed 4: Acrylic acid

| | |
|---|---|
| 7.00 | g of acrylic acid |
| 6.00 | g of water |

### Results

### Properties of the Resulting Polymer Dispersions

| | Comparative example | Example |
|---|---|---|
| Solids content in % by wt. | 50.4 | 49.3 |
| Particle size | 381 | 393 |
| (determined by hydrodynamic | | |
| chromatography, HDF) | | |
| Polydispersity | 0.13 | 0.138 |
| pH | 3.3 | 3.3 |
| Transparency in % | 28 | 27 |
| Amount of coagulate in g | 2 | 2 |

### Production of the Films

The dispersions from the example and comparative example were applied with a doctor blade (layer thickness 60 μm, wet) to a corona-pretreated polypropylene (PP) foil (temporary carrier), dried and heat-treated at 70° C. for one hour. Afterward, the film with the foil was laminated onto an elastomeric, black substrate at room temperature with a rubber roll.

Production of the substrate: Acronal® S360 D, a polyacrylate dispersion from BASF, was diluted to a solids content of 45% by weight and colored with 2.5 parts by weight of Basacid Black to 100 parts by weight of polymer, and a film (layer thickness 450 μm wet) on a PP substrate was produced therefrom.

The resulting laminate was heat-treated at 140° C. in a drying cabinet for 30 seconds and the PP film was removed after cooling. The color properties of the resulting coating of the inventive film on the black polyacrylate substrate were assessed visually, and the angle dependency was also determined with the data color MultiFX 10 spectrophotometer. In the table which follows, L is a measure of the brightness, and a, b a measure of the color intensity:

+a=red, −a=green, +b=yellow, −b=blue; it is generally the case that a high absolute value for a or b (irrespective of the sign) means a high color intensity

### Visual Assessment:

Comparison: homogeneous film, red in color, extensible through intense green to blue, reversible
Example: as comparison, but distinctly more intense and brilliant colors; at 20% extension: intense green; at 40% extension: green-blue; at 60% extension: blue-violet

| Angle | L | | a | | b | |
|---|---|---|---|---|---|---|
| pair | Comparison | Example | Comparison | Example | Comparison | Example |
| 25°/170° | 38.83 | 47.68 | −11.02 | −11.13 | −4.99 | −5.08 |
| 25°/140° | 48.95 | 59.53 | −49.32 | −58.93 | 24.19 | 30.69 |
| 45°/150° | 51.61 | 59.15 | −43.87 | −45.78 | 34.36 | 36.55 |
| 45°/120° | 45.70 | 56.41 | 6.26 | 8.56 | 35.97 | 46.26 |
| 75°/120° | 37.57 | 42.82 | 30.55 | 34.61 | 20.43 | 23.24 |
| 75°/90° | 30.14 | 37.41 | 30.71 | 40.43 | 6.39 | 11.56 |
| 45°/110° | 27.82 | 35.53 | 12.94 | 17.79 | 17.75 | 27.57 |
| 45°/90° | 11.59 | 12.38 | 8.54 | 9.93 | −5.56 | −5.02 |
| 45°/60° | 8.74 | 7.99 | 1.19 | 0.46 | −7.08 | −8.61 |
| 45°/25° | 9.6 | 9.45 | 1.66 | −1.38 | −5.20 | −5.94 |

1: A process for improving the color brilliance of a color polymer system which is composed of a matrix and discrete polymer particles which are distributed in the matrix in accordance with a defined spatial lattice structure and are obtained by filming an emulsion polymer having a core/shell structure, wherein the emulsion polymer is obtained by polymerization of monomers in at least one first stage (monomers of the core) and subsequent polymerization of monomers in at least one further, second stage (monomers of the shell), which comprises polymerizing the monomers of the core in the presence of a UV absorber.

2: The process according to claim 1, wherein the monomers of the shell consist to an extent of at least 5% by weight of monomers having a glass transition temperature of less than 0° C.

3: The process according to claim 1, wherein the monomers of the shell consist to an extent of from 0.01 to 10% by weight of crosslinking monomers.

4: The process according to claim 1, wherein ionic emulsifiers are used in the polymerization of the monomers of the core and nonionic emulsifiers are used in the polymerization of the monomers of the shell, or vice versa.

5: The process according to claim 1, wherein the monomers of the shell are metered into the polymerization within less than 90 minutes.

6: The process according to claim 1, wherein the polymer particles of the color polymer system are one or more different particle types having a mean particle diameter in the range from 0.05 to 5 μm, but each particle type having a polydispersity index (PI) less than 0.6, calculated by the formula
P.I.=(D₉₀−D₁₀)/D₅₀
in which D₉₀, D₁₀ and D₅₀ designate particle diameters for which:
D₉₀: 90% by weight of the total mass of all particles have a particle diameter less than or equal to D₉₀
D₅₀: 50% by weight of the total mass of all particles have a particle diameter less than or equal to D₅₀
D₁₀: 10% by weight of the total mass of all particles have a particle diameter less than or equal to D₁₀.

7: The process according to claim 1, wherein the polymer particles of the color polymer system are of one particle type.

8: The process according to claim 1, wherein the emulsion polymer is composed overall to an extent of at least 40% by weight of so-called main monomers selected from C₁ to C₂₀ alkyl (meth)acrylates, vinyl esters of carboxylic acids comprising up to 20 carbon atoms, vinylaromatics having up to 20 carbon atoms, ethylenically unsaturated nitrites, vinyl halides, vinyl ethers of alcohols comprising from 1 to 10 carbon atoms, aliphatic hydrocarbons having from 2 to 8 carbon atoms and one or two double bonds, or mixtures of said monomers.

9: The process according to claim 1, wherein the polymer particles of the color polymer system and the matrix differ in the refractive index.

10: The process according to claim 1, wherein the difference in the refractive index is at least 0.01.

11. The process according to claim 1, wherein the polydispersity index of the discrete polymer particles is less than 0.45.

12: The process according to claim 1, wherein the core of the emulsion polymer has been crosslinked.

13: The process according to claim 1, wherein the weight ratio of the core to the shell in the emulsion polymer is from 1:0.05 to 1:20.

14: The process according to claim 1, wherein the distance between the discrete polymer particles of the color polymer layer is from 20 to 50 000 nanometers.

15: The process according to claim 1, wherein the polymer of the transparent layer is composed overall to an extent of at least 40% by weight of so-called main monomers selected from C₁ to C₂₀ alkyl (meth)acrylates, vinyl esters of carboxylic acids comprising up to 20 carbon atoms, vinylaromatics having up to 20 carbon atoms, ethylenically unsaturated nitrites, vinyl halides, vinyl ethers of alcohols comprising from 1 to 10 carbon atoms, aliphatic hydrocarbons having from 2 to 8 carbon atoms and one or two double bonds, or mixtures of said monomers.

16: A color polymer system obtainable by the process according to claim 1.

17: A method of using a color polymer system according to claim 1 as or in coating compositions for coating plastics, plastics films, fibrous systems of textiles or paper, packaging, or in visual displays with changing color of the polymer layer or for increasing the light yield in visual displays or for producing color pigments or for producing moldings which can be produced, by extrusion and can be used in automobile construction or the household.

18: A process for producing substrates coated with a color polymer system according to claim 1, which comprises applying the polymer system to a temporary carrier by filming an aqueous polymer system or by extrusion, and then transferring by laminating or pressing the resulting coated carrier by the coated side to the substrate, and, optionally, subsequently removing the temporary carrier.
